(19) United States
(12) Patent Application Publication
(10) Pub. No.: US 2026/0204531 A1
(43) Pub. Date: Jul. 16, 2026

(54) Plume Arrival Time Determination in Laser Ablation

(71) Applicant: Standard BioTools Canada Inc., Markham (CA)

(72) Inventors: Adam CAREW, Markham (CA); Alexander LOBODA, Markham (CA)

(73) Assignee: Standard BioTools Canada Inc., Markham, ON (CA)

(21) Appl. No.: 19/130,049

(22) PCT Filed: Nov. 15, 2023
(86) PCT No.: PCT/IB2023/061576

§ 371 Date: May 14, 2025

Related U.S. Application Data
(60) Provisional application No. 63/428,912, filed on Nov. 30, 2022.

(51) Int. Cl. H01J 49/04; G01N 1/44; H01J 49/00

(52) U.S. Cl. CPC H01J 49/0463; G01N 1/44; H01J 49/0004; H01J 49/0009

(57) ABSTRACT

Methods and systems to calculate the arrival time window of a plume at an analyzer is presented. The plume is generated from a tissue or geological sample by laser ablation. In some embodiments, an external sensor measures the ambient parameters such as temperature and pressure to calculate the arrival time window more accurately. In other embodiments, direct measurement of plume arrival times or non-contact measurement of the flow speed of the plume in a tube are used to determine the arrival time window of the plume at an analyzer.

### RELATED APPLICATIONS

This application claims priority to U.S. Provisional Application No. 63/428,912 filed on Nov. 30, 2022, the contents of which are incorporated herein in their entirety.

### TECHNICAL FIELD

The present disclosure relates to laser ablation and generation and analysis of plumes of biological matter.

### BACKGROUND

In existing Image Mass Cytometry™ (IMC™) or Laser Ablation Inductively Coupled Plasma Mass Spectrometry (LA-ICPMS) systems, each pixel of an image corresponding to a sample is generated via analysis of one or more plumes produced by ablation of a portion of the sample corresponding to that pixel. Laser pulses can be used to convert a solid sample into a plume of nanoparticles.

To achieve an accurate association with Imaging Mass Cytometry (IMC) and other laser ablation inductively-coupled plasma mass spectrometric (LA-ICPMS) imaging techniques, some method is required to associate the generation of the material that is analyzed for a given pixel in the image with the corresponding mass spectrum (or spectra) generated from that material. In this way, the acquisition system generates summed “counts” for each pixel.

In a typical IMC or LA-ICPMS system, the solid sample is converted into a plume of nanoparticles by at least one laser pulse. Pulse trains can also be used depending on sample, laser and pixel size considerations. The aerosol plume expands into an ablation gas (usually Helium), which flows over the sample surface and carries the plume material to the ionization source, usually through a transfer tube for downstream analysis.

To achieve an accurate association between a mass spectrum (or mass spectra) of one or more plumes with a particular pixel in the image, accurate travel times of plumes from the ablation location(s) to a downstream analysis stage are needed. The accurate association between the one or more mass spectra with one or more ablation locations on the sample allows an acquisition system to generate correct summed “counts” for each pixel. In other words, it allows the acquisition system to correctly aggregate data from one or multiple plumes corresponding to the same pixel. As pixel acquisition rates increase, so does the requirements for good timing fidelity since the time width of an acquisition window decreases with increasing pixel acquisition rate. Consequently, a fixed timing jitter or drift will represent a larger percentage of the window width at higher acquisition rates.

### SUMMARY

In one aspect, a method for use in imaging mass spectrometry is disclosed, which comprises generating a plume from a sample tissue using laser ablation, causing the plume to flow in a carrier gas along a plume transfer path to an analyzer, measuring a set of parameters of the carrier gas at one or more locations along the plume transfer path, wherein the set of parameters includes at least one of a temperature and a pressure, and utilizing the set of parameters in combination with a flow rate of the carrier gas to determine an arrival time of the plume at the analyzer.

The plume arrival time can be determined via application of one or more corrections based on variation of the set of parameters with respect to a reference set of parameters. In some embodiments, a mass flow controller (MFC) can be used to measure a flow rate of the plume and the MFC flow rate can be adjusted based on the set of parameters to correct for the plume arrival time at the analyzer. In some embodiments, the set of parameters can be updated based on a predefined schedule.

In a related aspect, a method for use in imaging mass spectrometry is disclosed, which comprises generating a plume from a sample tissue using laser ablation, causing the plume to flow to an analyzer, measuring plume arrival times at the analyzer for a plurality of plumes, determining a plume acquisition window timing based on the measurements, wherein the determination of the plume acquisition window is based on an external standard included on a same substrate as a tissue sample.

By way of example, the external standard can be at least one of melted beads and tuning tape.

In a related aspect, a method for use in imaging mass spectrometry is disclosed, which comprises generating a plume from a sample tissue using laser ablation, causing the plume to flow to an analyzer through a transfer tube, measuring flow speed of the plume in the transfer tube with a non-contact sensor, and calculating a plume acquisition window based on the measurement.

By way of example, the non-contact sensor can be an ultrasonic transducer.

Some embodiments present an imaging mass spectrometric system, comprising a laser configured to generate radiation suitable for causing ablation of a sample to generate an ablation plume, an analyzer configured to receive the ablation plume and generate a mass imaging analysis of the plume, a transfer tube positioned to receive the plume and provide a flow path for delivering the plume to the analyzer, a source of carrier gas configured to provide a flow of a carrier gas over the sample to facilitate flow of the ablation plume through the transfer tube, at least one of a temperature sensor and a pressure sensor positioned relative to the transfer tube to measure at least one of temperature and pressure at one or more locations along the flow path, and a controller in communication with said temperature and pressure sensor, the controller being configured to receive any of temperature and pressure data generated by the respective sensor and process the data for correcting a reference travel time of the plume from the ablation site to the analyzer.

In some embodiments, the imaging mass spectrometric system can further comprise a mass flow controller (MFC) configured to measure a flow rate of the plume. In some embodiments, the controller can be further configured to send control signals to the MFC so as to adjust the MFC flow rate based on the corrected travel time.

Further understanding of various aspects of the embodiments can be obtained by reference to the following detailed description in conjunction with the associated drawings, which are described briefly below.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in this specification and constitute a part of it, illustrate several embodiments consistent with the disclosure. Together with the description, the drawings serve to explain the principles of the disclosure.

In the drawings:

FIG. 1 is a flow chart depicting various steps in an embodiment of a method according to the present inventions for correcting plume arrival times;

FIG. 2 schematically depicts a system according to an embodiment for correcting plume arrival time;

FIG. 3 depicts an example of tagged plumes and the potential for cross talk, illustrating change in optimal delay (aka Plume Start Delay) in the position of plumes with respect to laser TAG triggers that were observed over time;

FIG. 4 depicts experimental plume start value determinations;

FIG. 5 depicts experimental measurements of temperature and pressure; and

FIG. 6 depicts experimental correction results for plume start error.

### DETAILED DESCRIPTION

Present embodiments relate to the analysis of samples, such as geological samples, or biological samples, e.g., tissues and cells and/or individual microparticles or nanoparticles for analysis such as mass spectrometry and mass cytometry with inductively coupled plasma and similar elemental ionization technologies.

As explained above in a typical IMC or LA-ICPMS system, a solid sample is converted into an aerosol plume of nanoparticles by at least one laser pulse. Pulse trains can also be used depending on sample, laser and pixel size considerations. The aerosol plume expands into an ablation gas (usually Helium), which flows over the sample surface and carries, typically through a transfer tube, the plume material to an ionization source of a downstream mass analyzer.

Due to engineering constraints related to gas handling, RF shielding and thermal management, there is typically a minimum distance over which a plume must travel to be transferred between the sample and the downstream ionization source.

For some conventional systems (e.g., in some conventional LA-ICPMS systems), such a distance can be 40-60 cm, to allow dual mode use of the mass analyzer, including a suspension and an imaging mode.

This distance leads to a delay and is an important consideration for establishing a correlation between the generation of a plume at the site of ablation, e.g., produced via laser ablation, associated with a pixel generated by an image analyzer and the detection of the plume by the mass analyzer. The establishment of such a correlation between the generation of the plume and its detection by the mass analyzer requires consideration of the travel time of the plume from the ablation site to the mass analyzer, e.g., through an ionization plasma, ion optics and a detector. In many cases, the time spent by the plume to travel between the ablation site and an ionization plasma of a downstream mass analyzer, e.g., via passage through a transfer tube, constitutes most of this time period, e.g., about 10-40 ms, compared to a typical transit time of about 30 μs in the ion optics.

Imaging Mass Cytometry™ (IMC) requires good time fidelity of the arrival of the ablation plumes in the plasma in order to construct the ion image from the detected plume sequence. In this context, “time fidelity” refers to how well correlated the arrival time of the plume to the plasma is to the time of the corresponding laser shot, as well as how narrowly-distributed the arrival times of the individual particles that make up the plume are. These two effects may also be described as “arrival time jitter” between individual plumes and as “time broadening” of individual plumes during transit. Without sufficient timing fidelity, plumes from sequential laser ablation events can blur together, resulting in a “smearing” of the final tissue image (reconstructed from ion signals) or other serious imaging artifacts, which is undesirable.

Conventional approaches for calculating a correlation between the generation of a pixel plume and the detection of the plume assume that the time it takes for a plume to travel through the transfer tube is constant for different plumes arriving at different times. Accordingly, in such conventional approaches, the transit time of a plume (herein also referred to as the plume transit time interval) is measured as a function of one or more flow parameters of a carrier gas used to facilitate the transfer of the plume through the transfer tube to the downstream mass analyzer. The delay time between a trigger signal for generating a laser ablation pulse and the start of an acquisition window of a detector of the mass analyzer is set based on this plume transit time interval. However, assuming a fixed delay time is only a good assumption if both the ambient temperature and pressure remain constant. In fact, the ambient temperature and/or pressure may change during data acquisition interval and hence affect the plume transit time from the ablation site to the mass analyzer. By way of example, variations of ambient temperature and/or pressure can influence the operation of a mass flow controller utilized for establishing a desired flow rate of the carrier gas, thereby causing errors in the conventional ways of determining the plume transit time.

By way of illustration and to facilitate the discussion of various embodiments of the present inventions, the operation of a mass flow controller is briefly described. A mass flow controller (MFC) is a device that uses a thermal sensor and a proportional valve to set a desired gas flow rate through it. It works by assuming that the heat transfer capacity of a gas depends only on the number of gas molecules flowing over a sensor unit, although, some MFCs also may correct for thermal variation in the heat capacity of the gas. By applying heat to the gas and measuring the increase in the gas temperature at some point downstream, the rate of flow past the sensing element can be inferred. A valve in the MFC is then used to stabilize the flow (in molecules/s) at a desired setpoint chosen by the user.

The flow rate in an MFC is indicated by the units that are used to specify mass flow in MFCs—SLPM. This unit is “standard liters per minute,” where the “standard” refers to standard temperature and pressure conditions, which are 0° C. and 100 kPa. It is only at Standard Temperature and Pressure (STP) conditions that the mass flow from the MFC (SLPM) will be equal to the volumetric flow (in L/min). Any deviation from STP conditions will affect the volumetric flow output.

For typical conditions in the gas conduit, the behavior of the MFC gas is well modeled by the ideal gas law, which models the volume of a gas as being linearly proportional to its temperature, and inversely proportional to its pressure:

$$V = \frac{n R T}{P} , \qquad Eq . ( 1 )$$

In Eq. 1, V represents the volume of gas being considered. The number n represents the number of moles of gas in the volume. R represents the gas constant, 8.314 J/mol·K, and it is related to the Boltzmann constant via multiplying the Avogadro number by the Boltzmann constant. T and P represent, respectively, the temperature and the pressure of the gas in volume V.

It can be seen that for a constant flux of gas molecules (i.e., constant n), V will only be constant if both T and P are also both constant, as is generally expected in the gas conduit where pressure is about 1 atm and temperature is at room temperature.

In the gas conduit the assumption of constant transit time of plumes from an ablation site to an ionization plasma is only accurate if the speed of the gas flow remains constant during data acquisition. Gas flow speed, however, is determined by the volumetric flow rate and the dimensions of an inner channel of the transfer tube. The volumetric flow rate of the gas can depend on the ambient temperature and pressure. Consequently, the speed of gas flow can also depend on the ambient pressure and temperature. Drift of gas flow speed will translate into the drift of the optimal plume start. In IMC or other laser ablation areas with high pixel rates, it was unclear if drift of plume start would influence measurement of ion signal for a particular pixel.

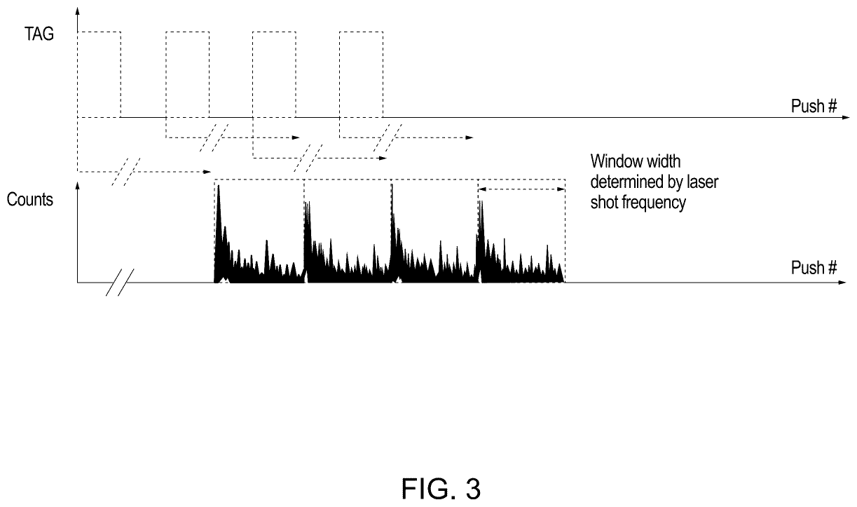

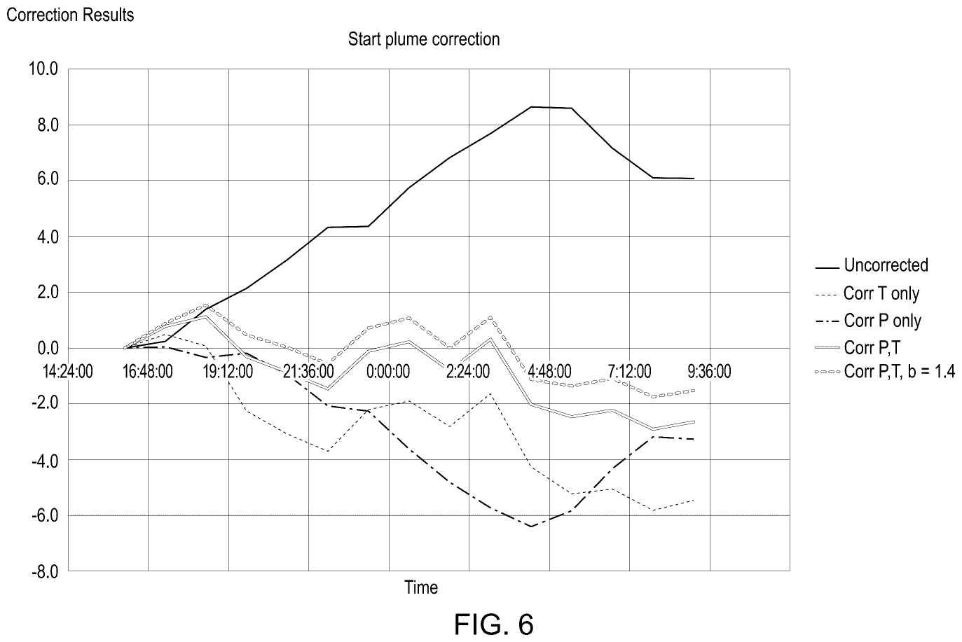

During an experiment that measured the change in optimal delay (aka Plume Start Delay), large shifts (~20 TOF pushes) in the position of the plumes with respect to the laser TAG triggers were observed over time as shown in FIG. 6. As shown in FIG. 3, each plume is associated with a “tag” input. This is a channel in the acquisition system that identifies the arrival of the laser pulse and allows the system to identify the range of the TOF (time-of-flight) pushes that correspond to that laser shot. For example, the portion of the signal from one laser shot which lies inside other windows is the “cross talk” (CT) for that plume. Usually, several plumes are summed together to generate a cleaner, more representative “accumulated” transient, which is used to perform cross talk measurement. TOF pushes are used in the software as a unit of timing in CyTOF®. In CyTOF XT™, where the time between two consecutive pushes is 13 μs.

The observed shifts were seen to be correlated with the recorded temperature and pressure changes during the data acquisition. In this particular experiment, in which the operation at a pulse ablation rate of about 800 Hz was of interest, the acquisition window was set to be 96 pushes wide (corresponding to the duration between consecutive laser shots measured in TOF push intervals). Accordingly, in such a case, a 20-push drift in the plume position would result in a non-negligible fraction of the width of a typical plume. This shift would manifest itself as an additional source for cross talk between pixels, i.e., the spread of signals from drifted plumes across multiple pixels.

Without being limited to any particular theory, it is believed that such fluctuations stem from fluctuations in the speed of gas flow through the transfer tube. Accordingly, shortening the transfer tube may reduce such fluctuations. For example, a given change in the flow velocity produces a 10× larger shift in a 40 cm long tube than it does in a 4 cm long tube. However, it is not always simple or even possible to shorten the transfer tube. In addition, whatever length of transfer tube is used, it is desired to minimize such fluctuations.

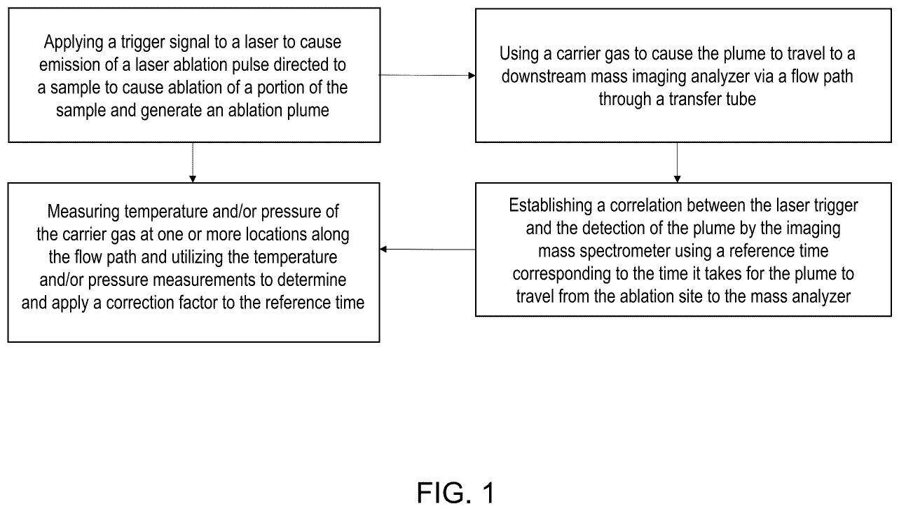

FIG. 1 is a flow chart depicting various steps in a method according to an embodiment for use in imaging mass spectrometry, which includes applying a trigger to a laser to cause the laser to generate an ablation radiation pulse directed to the sample to cause ablation of a sample portion to generate a plume and using a carrier gas to cause the plume to travel to a downstream mass imaging analyzer via a flow path through a transfer tube. A correlation between the laser trigger and the detection of the plume by the mass analyzer can be established using a reference time corresponding to the time it takes for the plume to travel from the ablation site to the mass analyzer. A temperature and/or pressure of the carrier gas at one or more locations along the flow path can be monitored, e.g., according to a predefined schedule or continuously, and such temperature/pressure measurements can be utilized to apply a correction factor to the reference time to substantially compensate for errors, if any, in the reference time due to variations in any of the temperature and/or pressure. Such automated correction permits automated improved correlation of the time spent by a plume transiting between the ablation site and the plasma, improving assignment of ion signal to the corresponding pixel.

According to some embodiments, the correction for such fluctuations in the gas speed due to changes in the ambient temperature and/or pressure can be performed by measuring a plurality of operational parameters during the initial tuning of the instrument. More specifically, in some embodiments, the tuning parameters can include T₀, P₀, and PS₀, namely, an initial temperature (T₀), an initial pressure (P₀), and an optimal plume start (PS₀). In many cases, all of the tuning parameters are recorded at the same time. As noted above, the plume start (PS₀) refers to a time delay utilized by a system according to various embodiments of the present teachings corresponding to the time interval between the time at which an ablation laser pulse associated with a pixel is triggered and the beginning of a time window for integrating the signal of that particular pixel. In some embodiments, the PS₀ can be measured in units of TOF pushes.

In some embodiments, the temperature and the pressure can be monitored (measured) at a plurality of times during data acquisition, e.g., based on a regular basis. And the temperature and pressure data can be utilized to correct for the plume transit time through the transfer tube. Such a correction of the plume transit time can be achieved, for example, by adjusting the plume start time (PS) using the acquired temperature and pressure data.

For example, in some embodiments, on a regular basis during data acquisition, the current value of PS can be corrected using the following relation:

$$P {S}_{n} = P {S}_{0} ( 1 + a ( \frac{{T}_{n} - {T}_{0}}{{T}_{0}} ) + b ( \frac{{P}_{n} - {P}_{0}}{{P}_{0}} ) ) \qquad Eq . ( 2 )$$

where PSₙ represents the n^{th} correction applied to the PS₀ plume start value, and Tₙ and Pₙ are the measured temperature and pressure, respectively, for the n^{th} correction.

The above parameters a and b can be used to adjust the contribution of each of the temperature and the pressure terms. In some embodiments, the values of the a and b parameters can be determined theoretically and/or empirically. By way of example, and without limitation, the following default values can be employed a=−1 and b=1. These default values reflect the fact that the hotter the gas the more volume it occupies. Accordingly, an increase in the gas temperature decreases the plume arrival time due to an increase in the gas speed traveling through the transfer tube. The inverse is true for pressure.

According to various embodiments, different formulas could be used to compensate for temperature and pressure fluctuations. For instance, in some embodiments, the parameters a and b can be utilized to adjust the strength of their respective corrections. Further, the above relation for correcting the pulse start time can be used over a wide range of temperatures and/or pressures. Considering typical fluctuations in temperature and pressure, in many cases, the corrections are small enough that the linearization is reasonable.

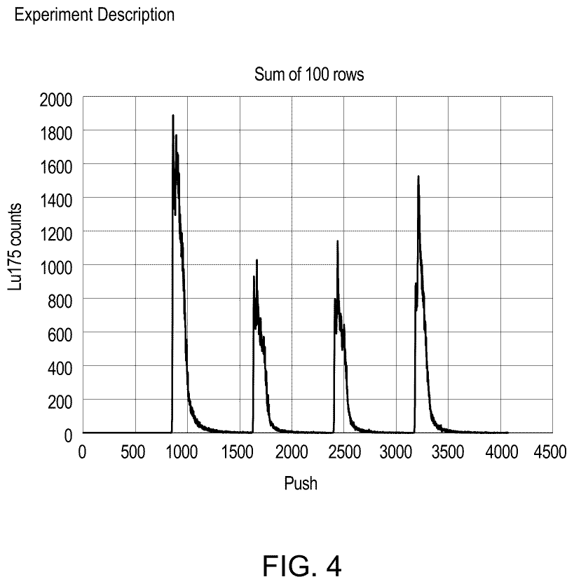

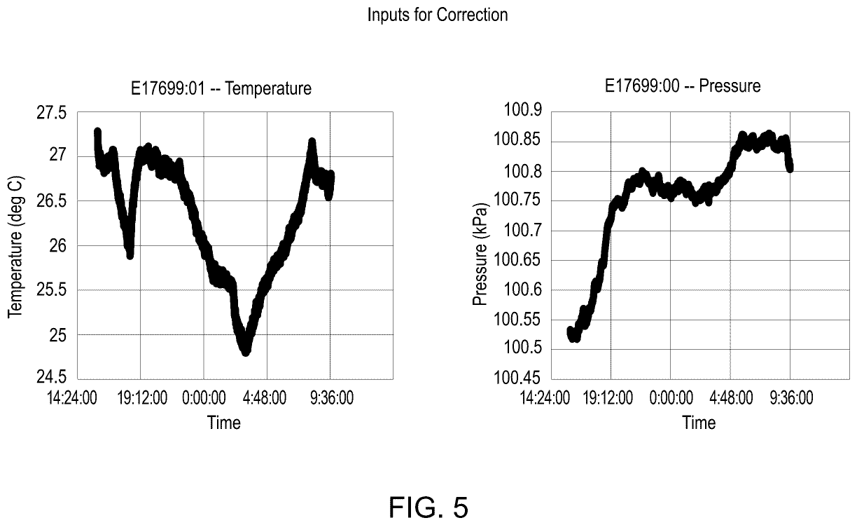

In the experiments performed according to such embodiments, data showed that the method produced proper corrections for the plume start value based on the ambient T and P measurements. As illustrated in FIG. 4, in an overnight batch run, laser microdissection (LMD) was recorded hourly from 4×100 ROI on tuning film; plume start values were extracted by convolving 800 Hz acquisition window with raw plume data and finding peaks in the resulting waveform. Same step as first plume start estimation was used for transient calibration. As illustrated in FIG. 5, ambient temperature and pressure values were simultaneously recorded using a Dracal USB-PTH200 sensor unit. Correction results are shown in FIG. 6. Standard deviation of plume start value on tuning film is ~5 pushes. Correction error <5 pushes should be undetectable. Corrections based on temperature and pressure showed improvement in plume start error, with an additional possible improvement by optimizing a, b parameters for linearization.

In some embodiments, the plume start value can be corrected by actively recording the arrival time of the plumes throughout the data acquisition period and using the arrival time as feedback. These embodiments have the benefit of not requiring assumptions about the dependence of the drift in the plume arrival time on T and P. Rather, a drift in the plume arrival time is measured and corrected directly. For example, a change in the arrival time may be identified and used to correct the plume arrival times. For example, CyTOF utilizes a tuning film (a thin plastic film on top of a microscope slide which is doped with controlled amounts of detectable elements) for auto-tuning various operation parameters in IMC mode. One of the parameters that the analyzer (which can be implemented as software (SW)) measures is the Plume Start. The measurement is done by firing laser pulses at a low repetition rate and then observing a signal transient corresponding to each laser shot. By analyzing the shape and delay of the transient the SW derives the optimal value of Plume Start from such transients. If a system needs to correct for the drift in the Plume Start, one possible solution is to periodically pause on the imaging of the tissue, return to the tuning film and measure the new value of the optimal Plume Start. This method introduces disruptions into the imaging process and complicates the SW logic. The term “a transient” as used herein refers to several plumes all grouped together, associated with a pixel. A laser shot produces a plume of particles from the sample. The plume travels to the plasma, through the plasma and into the mass spectrometer. The signal of ions from the ablated material produces a transient signal which is often simply called a transient.

In yet another embodiment, the sample of interest contains a sufficient amount of an element that can be used to measure transients with sufficient fidelity to derive the optimal Plume Start. Thus, correction of Plume Start drift can be carried out concurrently with ablation of the sample. This approach has a downside that a special and relatively bright elemental staining needs to be added to every sample which transfers complexity to the extra work that a user needs to perform.

In some embodiments, the plume arrival times can be measured at intervals during data acquisition (e.g., during acquisition of imaging mass data from a tissue sample) on an external standard that is included on the same substrate, e.g., the same slide, as the sample. Some examples of such external standards include, without limitation, melted beads or tuning tape (WO2020055743A1; WO2019210233A1 incorporated herein by reference in their entirety).

In some embodiments, the plume arrival times can be measured using application of some internal standard to the sample (e.g., a tissue sample). By way of example, such an internal standard can exhibit uniform ablation properties and metal content and not affect the quality of the sample (e.g., tissue) images. In these embodiments, the ablation of the sample would produce both the data of interest, plus “real time tuning” data that could be used to measure/correct for instrument drifts associated with plume arrival times on the fly. In other words, in some embodiments, the optimal plume start value (PS₀) can be measured while conducting imaging of a tissue sample. In such cases, the optimal value of (PS₀) can be corrected in real time by switching to the corrected value. This is in contrast with a workflow in which the tissue imaging is stopped and the system switches to a tuning protocol and following the tuning protocol, the system reverts to conducting imaging of the sample.

In some embodiments, a gas flow speed controller different than an MFC gas flow controller can be utilized for measuring the gas flow speed. For example, in some such embodiments, the speed of gas flow through the transfer tube can be measured. In these embodiments, the measurement of the gas flow is preferably performed without perturbing the plumes during the measurement. By way of example, in some embodiments, a non-contact sensing device can be used to measure the speed of gas flow through the transfer tube. An example of such non-contact sensing devices is, without limitation, an ultrasonic transducer.

In some embodiments, the MFC flow rates can be adjusted, related to both makeup gas and/or chamber gas, based on the measured temperature and pressure to stabilize the plume arrival time. In such embodiments, attention should be paid to the fact that variations in the mass flow rate of the gas through the injector of an MFC flow controller could affect the plasma composition and likely have some effects on sensitivity or oxide formation. Accordingly, in these embodiments, the user can compensate for this effect by adjusting the RFG power to maintain stable sensitivity/oxides.

In some embodiments, by changing gas flows one can maintain the optimal Plume Start constant. The next parameter to control is Plume Broadening. Again, with two parameters (Make Up gas and Chamber gas) one can keep Plume Start and Plume broadening relatively stable. But changes in gas flows into plasma may also impact the temperature in the ionization zone. That in turn can affect ionization efficiency and production of oxides. Thus, in some cases, the two gases alone may not be sufficient to stabilize the three parameters, namely, the plume start, the plume broadening and temperature of the plasma in the ionization region. In some embodiments, the RF power can be utilized to control the temperature in the ionization region.

The present teachings advantageously allow reducing the temporal width of data acquisition window associated with each pixel to increase the pixel acquisition rate. As noted above, narrower data acquisition windows can render the measurements more sensitive to drifts of plume arrival time due to variations in ambient conditions. In various embodiments, the correction of drifts in plume arrival times can be employed to allow data acquisition at a high pixel rate while maintaining the image quality.

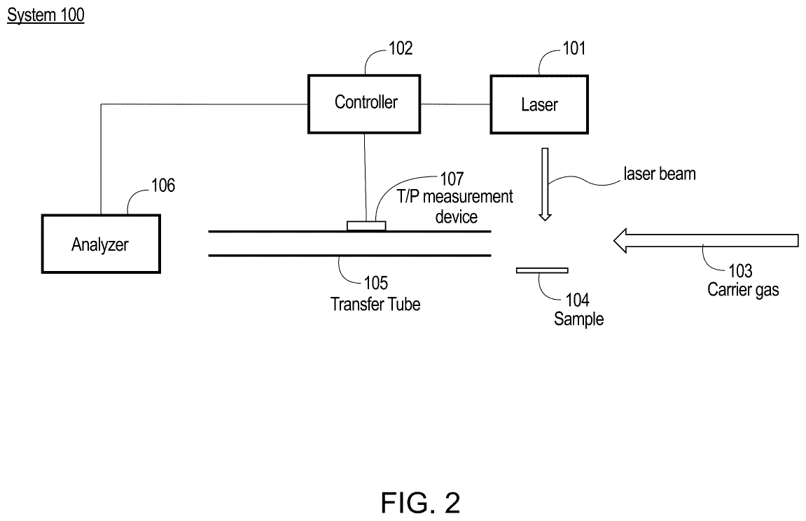

FIG. 2 schematically depicts an imaging mass spectrometric system 100 according to an embodiment, which includes a laser 101 that generates a laser radiation beam suitable for ablation of a sample 104. The laser 101 operates under the control of a controller 102 that supplies a trigger for causing the laser to emit an ablation pulse. The interaction of the laser ablation pulse with the sample causes ablation of a portion of the sample that is exposed to the laser beam to generate a plume, e.g., a plume of nanoparticles. The plume expands into a carrier gas (herein also referred to as ablation gas), which flows over the sample surface and carries the plume material via a transfer tube to a downstream mass imaging analyzer 106. A temperature/pressure measurement device 107 operating under the control of the controller 102 can be coupled to the transfer tube 105 to measure the temperature and pressure of the carrier gas and the entrained plume at one or more locations along the path provided by the transfer tube. The controller can receive these temperature/pressure measurements and utilize the measurements in a manner disclosed herein to generate a correction factor for application to a reference travel time that the controller can calculate based on the flow rate of the carrier gas and the distance between the ablation site and the downstream imaging mass analyzer, e.g., the ionization chamber of the downstream imaging mass analyzer.

As mentioned above, in some embodiments other systems can be utilized as alternatives to measuring temperature and/or pressure in order to:
(1) actively recording the arrival time of the plumes at the Analyzer 106 throughout the data acquisition period and use it as feedback using the Controller 102.
(2) the plume arrival times can be measured at intervals during data acquisition (e.g., during acquisition of imaging mass data from a tissue sample) on an external standard that is included on the same substrate, e.g., the same slide, as the sample.
(3) In some embodiments, the plume arrival times can be measured using application of some internal standard to the sample (e.g., a tissue sample).

### CONCLUSION AND GENERAL TERMINOLOGY

The above detailed description refers to the accompanying drawings. The same or similar reference numbers may have been used in the drawings or in the description to refer to the same or similar parts. Also, similarly named elements may perform similar functions and may be similarly designed, unless specified otherwise. Details are set forth to provide an understanding of the exemplary embodiments. Embodiments, e.g., alternative embodiments, may be practiced without some of these details. In other instances, well known techniques, procedures, and components have not been described in detail to avoid obscuring the described embodiments.

The foregoing description of the embodiments has been presented for purposes of illustration only. It is not exhaustive and does not limit the embodiments to the precise form disclosed. While several exemplary embodiments and features are described, modifications, adaptations, and other implementations may be possible, without departing from the spirit and scope of the embodiments. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature may exist in one or more embodiments.

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or. Moreover, if these terms are used, a subset of a set may include one or more than one, including all, members of the set.

Further, if used in this disclosure, and unless stated or deducted otherwise, a first variable is an increasing function of a second variable if the first variable does not decrease and instead generally increases when the second variable increases. On the other hand, a first variable is a decreasing function of a second variable if the first variable does not increase and instead generally decreases when the second variable increases. In some embodiment, a first variable may be an increasing or a decreasing function of a second variable if, respectively, the first variable is directly or inversely proportional to the second variable.

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise various steps may be omitted, repeated, combined, or performed in parallel, as necessary, to achieve the same or similar objectives. Similarly, the systems described need not necessarily include all parts described in the embodiments and may also include other parts not described in the embodiments. Accordingly, the embodiments are not limited to the above-described details, but instead are defined by the appended claims in light of their full scope of equivalents. Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

What is claimed is:

1. A method for use in imaging mass spectrometry, comprising:
generating a plume from a sample tissue using laser ablation,
causing the plume to flow in a carrier gas along a plume transfer path to an analyzer,
measuring a set of parameters of the carrier gas at one or more locations along the plume transfer path, wherein the set of parameters includes at least one of a temperature and a pressure, and
utilizing the set of parameters in combination with a flow rate of the carrier gas to determine an arrival time of the plume at the analyzer.

2. The method of claim 1, wherein the determination of the arrival time comprises applying one or more corrections based on variations of the set of parameters with respect to a reference set of parameters.

3. The method of claim 1, further comprising using a mass flow controller (MFC) to measure a flow rate of the plume and adjusting the MFC flow rate based on the set of parameters to correct for plume arrival time at the analyzer.

4. The method of claim 1, further comprising updating the set of parameters based on a predefined schedule.

5. A method for use in imaging mass spectrometry, comprising:
generating a plume from a sample tissue using laser ablation,
causing the plume to flow to an analyzer,
measuring plume arrival times at the analyzer for a plurality of plumes,
determining a plume acquisition window timing based on the measurements,
wherein the determination of the plume acquisition window is based on an external standard included on a same substrate as a tissue sample.

6. The method of claim 5, wherein the external standard is one of melted beads and tuning tape.

7. A method for use in imaging mass spectrometry, comprising:
generating a plume from a sample tissue using laser ablation,
causing the plume to flow to an analyzer through a transfer tube,
measuring flow speed of the plume in the transfer tube with a non-contact sensor, and
calculating a plume acquisition window based on the measurement.

8. The method of claim 7, wherein the non-contact sensor comprises an ultrasonic transducer.

9. An imaging mass spectrometric system, comprising:
a laser configured to generate radiation suitable for causing ablation of a sample to generate an ablation plume,
an analyzer configured to receive the ablation plume and generate a mass imaging analysis of the plume,
a transfer tube positioned to receive the plume and provide a flow path for delivering the plume to the analyzer,
a source of carrier gas configured to provide a flow of a carrier gas over the sample to facilitate flow of the ablation plume through the transfer tube,
at least one of a temperature sensor and a pressure sensor positioned relative to the transfer tube to measure at least one of temperature and pressure at one or more locations along the flow path, and
a controller in communication with said temperature and pressure sensor, the controller being configured to receive any of temperature and pressure data generated by the respective sensor and process the data for correcting a reference travel time of the plume from the ablation site to the analyzer.

10. The system of claim 9, further comprising a mass flow controller (MFC) configured to measure a flow rate of the plume.

11. The system of claim 10, wherein the controller is further configured to send control signals to the MFC so as to adjust the MFC flow rate based on the corrected travel time.
